(19) United States
(12) Patent Application Publication
(10) Pub. No.: US 2023/0239243 A1
(43) Pub. Date: Jul. 27, 2023

(54) MULTI-DOMAIN NETWORK DATA FLOW MODELING

(71) Applicant: QUALCOMM Incorporated, San Diego, CA (US)

(72) Inventors: Jordi ROS GIRALT, Vilafranca del Penedes (ES); Noah Isaac AMSEL, New York, NY (US)

(21) Appl. No.: 18/049,156

(22) Filed: Oct. 24, 2022

Related U.S. Application Data
(60) Provisional application No. 63/301,904, filed on Jan. 21, 2022.

(51) Int. Cl. H04L 47/11; H04L 47/2425

(52) U.S. Cl. CPC H04L 47/11; H04L 47/2425

(57) ABSTRACT

Various aspects of the present disclosure generally relate to wireless communication. In some aspects, a network entity may generate a first data flow model for a first domain associated with the network entity. The network entity may receive an indication of a second data flow model for a second domain that is different from the first domain. The network entity may selectively update the first data flow model based at least in part on whether the indication of the second data flow model indicates an error in the first data flow model. Numerous other aspects are described.

### CROSS-REFERENCE TO RELATED APPLICATION

This patent application claims priority to U.S. Provisional Patent Application No. 63/301,904, filed on Jan. 21, 2022, entitled “MULTI-DOMAIN NETWORK DATA FLOW MODELING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for multi-domain network data flow modeling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method performed by a network entity. The method may include generating a first data flow model for a first domain associated with the network entity. The method may include receiving an indication of a second data flow model for a second domain that is different from the first domain. The method may include selectively updating the first data flow model based at least in part on whether the indication of the second data flow model indicates an error in the first data flow model.

Some aspects described herein relate to a network entity. The network entity may include a memory and one or more processors coupled to the memory. The one or more processors may be configured to generate a first data flow model for a first domain associated with the network entity. The one or more processors may be configured to receive an indication of a second data flow model for a second domain that is different from the first domain. The one or more processors may be configured to selectively update the first data flow model based at least in part on whether the indication of the second data flow model indicates an error in the first data flow model.

Some aspects described herein relate to a non-transitory computer-readable medium that stores a set of instructions. The set of instructions, when executed by one or more processors of the network entity, may cause the network entity to generate a first data flow model for a first domain associated with the network entity. The set of instructions, when executed by one or more processors of the network entity, may cause the network entity to receive an indication of a second data flow model for a second domain that is different from the first domain. The set of instructions, when executed by one or more processors of the network entity, may cause the network entity to selectively update the first data flow model based at least in part on whether the indication of the second data flow model indicates an error in the first data flow model.

Some aspects described herein relate to an apparatus. The apparatus may include means for generating a first data flow model for a first domain associated with the apparatus. The apparatus may include means for receiving an indication of a second data flow model for a second domain that is different from the first domain. The apparatus may include means for selectively updating the first data flow model based at least in part on whether the indication of the second data flow model indicates an error in the first data flow model.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of network modeling, in accordance with the present disclosure.

FIGS. 4A, 4B, and 5 are diagrams illustrating examples associated with multi-domain network data flow modeling, in accordance with the present disclosure.

FIG. 6 is a diagram illustrating an example process associated with multi-domain network data flow modeling, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

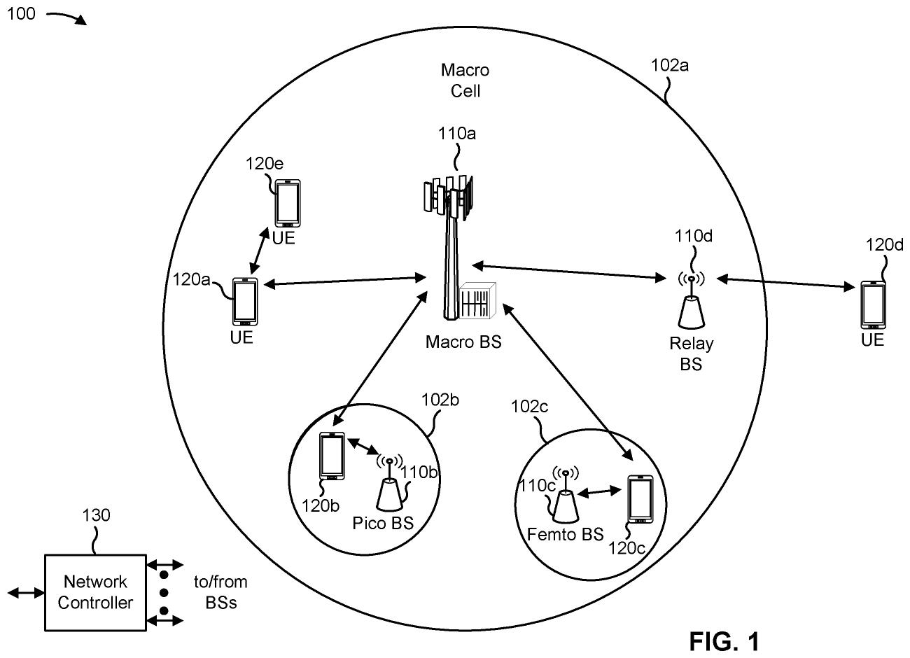

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

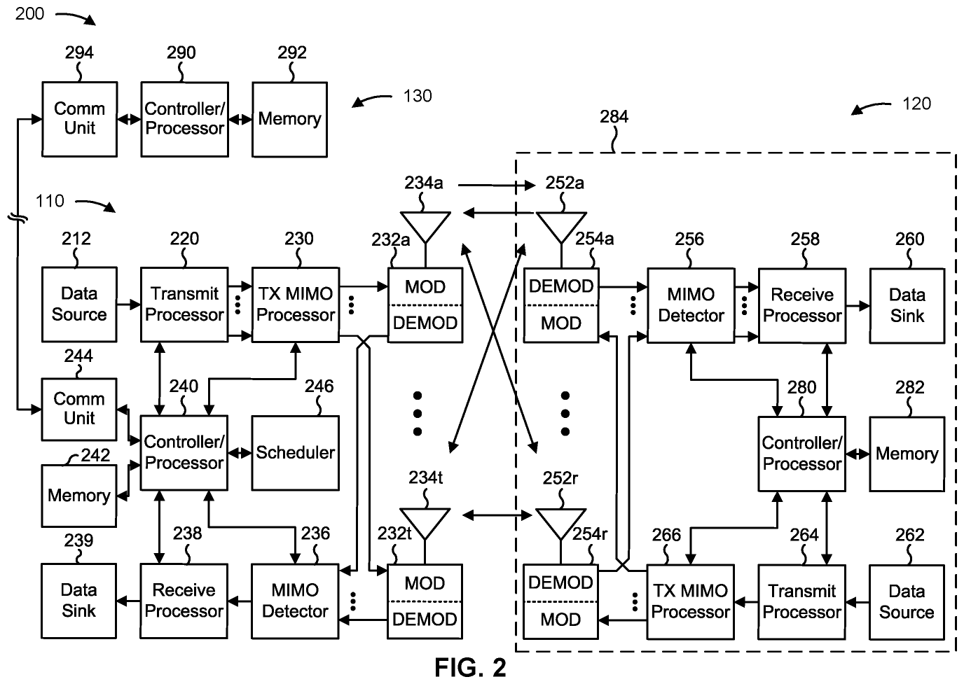

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

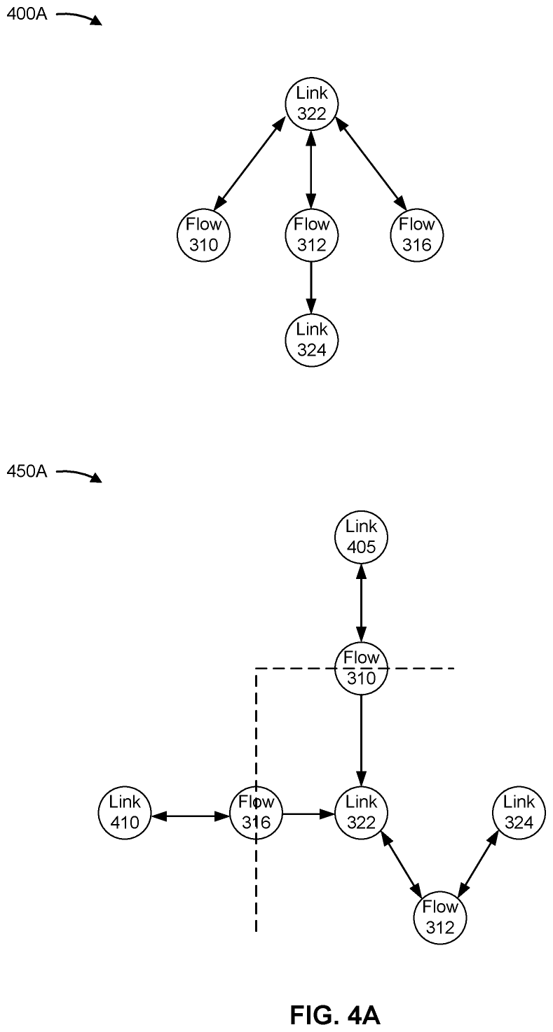

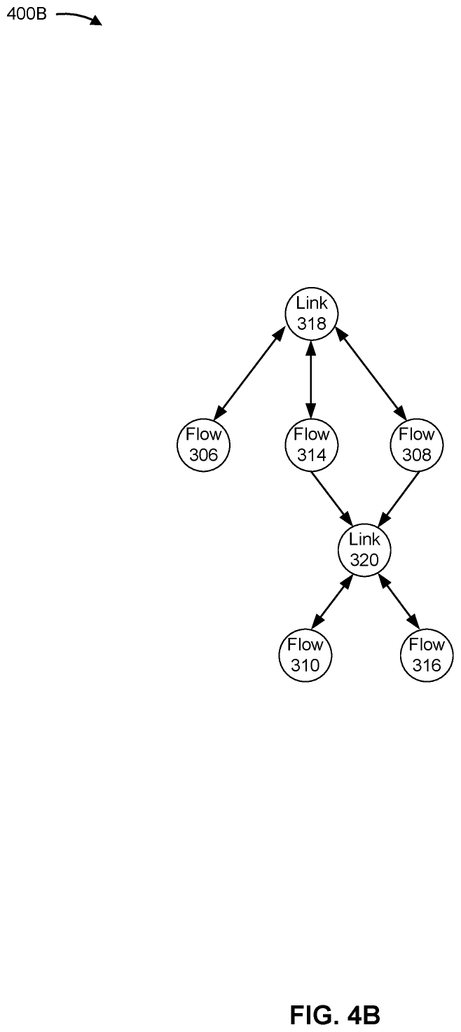

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-7).

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

In some communication environments, data flows traverse multiple domains (e.g., network domains), with each domain administered by a network entity (e.g., an operator) that is responsible for maintaining a local domain associated with the network entity (e.g., its own domain) and ensuring interoperability with others of the multiple domains traversed by a data flow. The data flows may, for example, carry data (e.g., a data stream) between multiple UEs, between a UE and an application server, between base stations, between backhaul nodes, and/or between base stations. The data flows provide a pathway for the data between end nodes associated with the data (e.g., between a receiving device and a transmitting device and/or between a generating device and a receiving device, among other examples). An example of a multi-domain network (e.g., a network including multiple domains) is the Internet itself, designed as a network of interconnected networks.

In multi-domain networking environments, each operator may have visibility of only a local network (e.g., devices and flows within a domain and/or a network associated with the operator). In particular, operators may determine a topology of the local network, a capacity of each link of the local network, classes of quality of service (QoS) available, and data flows currently active in their network, but usually have no knowledge about the structure and state of any other network in the multi-domain environment. For instance, a data flow may need to cross two network domains including a first domain associated with a first operator and a second domain operated by a second operator. The first operator may not have visibility into the second domain (e.g., a network within the second domain), and the second operator may not have visibility into the first domain (e.g., a network within the first domain). Therefore, each operator and/or domain may be unable to independently satisfy an end-to-end QoS as required by the data flow that extends across the first domain and the second domain.

To manage data flows within a domain (e.g., a network of devices within the domain), a network entity of the operator may generate and/or use a data flow model. The data flow model (e.g., a bottleneck structure and/or a flow gradient graph) may include a computational graph that characterizes a state of the domain, which may allow computation of network derivatives. These derivatives may be used to optimize the domain for traffic engineering, routing, flow scheduling, capacity planning, resilience analysis, and/or network design, among other examples. To generate the data flow model for the domain (e.g., the network of devices within the domain), the network entity may require information associated with a set of links traversed by flows of the domain and a capacity of the set of links. In a multi-domain networking environment, however, such information is only known partially. For instance, in the example above, a first network entity associated with the first operator associated with a first network entity may only have access to a first set of links, that reside within the first domain, traversed by a flow, but the first network entity may be unaware of a second set of links traversed by the flow that reside in the second domain. In some multi-domain networking environments, information of the second set of links may be considered confidential for security, privacy, and/or competitiveness reasons. Without the information of the second links, the first network entity may be unable to accurately generate the data flow model. Without the data flow model, the first network entity may be unable to compute network derivatives that would otherwise be used to conserve network resources (e.g., based at least in part on improved routing of data) and/or improve performance of the data flow.

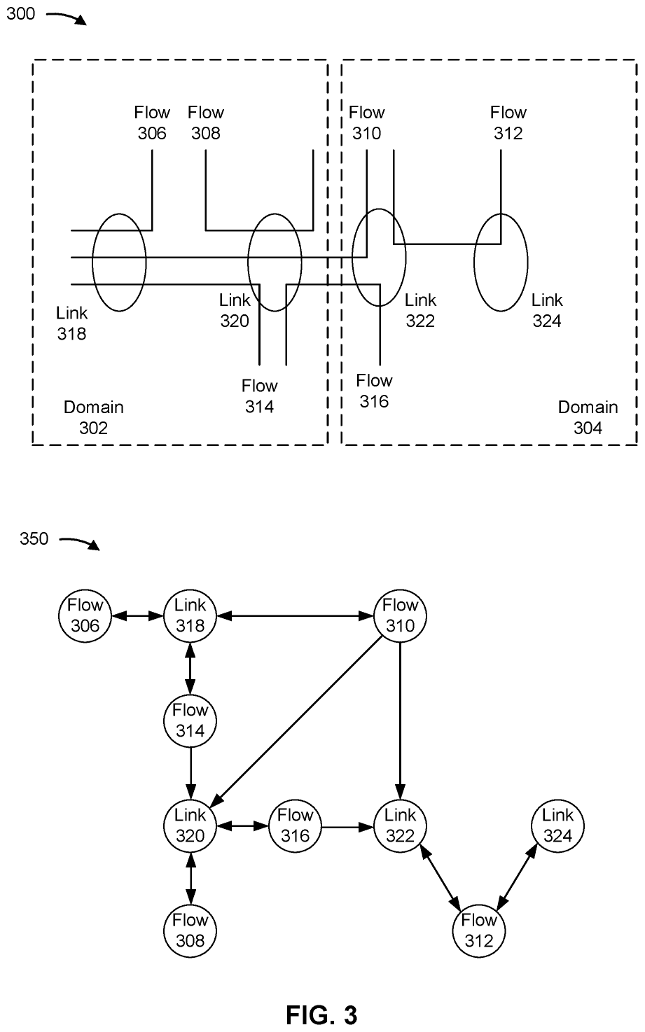

FIG. 3 is a diagram illustrating examples 300 and 350 of network modeling, in accordance with the present disclosure. As shown in example 300, a multi-domain network includes a first domain 302 and a second domain 304. The first domain 302 may be operated by a first network entity and/or a first operator, and the second domain 304 may be operated by a second entity and/or a second operator.

The multi-domain network includes multiple data flows (“flows”) and multiple links that connect two or more of the multiple data flows. Some of the data flows terminate on both ends within a single domain, and some of the data flows terminate within the first domain 302 at a first end and terminate within the second domain 304 at a second end. The multiple data flows may include one or more connected network devices (e.g., network nodes) and/or multiple network connections between the one or more network devices. The multiple links may include one or more networking nodes that include an ingress into, and/or egress out from, one or more of the multiple data flows such that data may move from one data flow to another data flow.

The multiple data flows include flow 306 that terminates within the first domain 302 at a first end and enters another domain that is not shown. Flow 308 terminates on both ends within the first domain 302. Flow 310 terminates within the second domain 304 and traverses the first domain 302 to terminate in another domain that is not shown. Flow 312 terminates on both ends within the second domain 304. Flow 314 terminates within the first domain 302 at a first end and enters another domain that is not shown. Flow 316 terminates within the first domain 302 at a first end and terminates within the second domain 304 at a second end.

The multiple links include link 318 that connects flow 306, flow 310, and flow 314 within the first domain 302. Link 320 connects flow 308, flow 310, flow 314, and flow 316 within the first domain 302. Link 322 connects flow 310, flow 312, and flow 316 within the second domain 304. Link 324 provides a connection to flow 312 that may be used to adjust a configuration of the second domain 304, or that may be used to connect flow 312 to another flow not shown in FIG. 3.

Each of the multiple links may be associated with a capacity. For example, link 318 may have a capacity of 25 units of data per second (e.g., gigabits per second), link 320 may have a capacity of 50 units of data per second, link 322 may have a capacity of 100 units of data per second, and link 324 may have a capacity of 75 units of data per second.

Each of the multiple data flows may be associated with an actual data flow rate based at least in part on the multiple data flows sharing capacities of the multiple links. For example, link 318 may divide the capacity of 25 units of data per second between communications with flow 306, flow 310, and flow 314. The data flow rate of flow 306 may be 8.3 units of data per second, the data flow rate of flow 308 may be 16.6 units of data per second, the data flow rate of flow 310 may be 8.3 units of data per second, the data flow rate of flow 312 may be 75 units of data per second, the data flow rate of flow 314 may be 8.3 units of data per second, and the data flow rate of flow 316 may be 16.6 units of data per second. Based at least in part on the data flow rates, one or more of the links may be bottleneck links (e.g., a link that reduces the data flow rates that could otherwise be higher if the link had higher capacity). Bottleneck links of a data flow may include a set of link vertices in a data flow structure such that there exists a directed edge from any of these links to the data flow.

Example 350 shows a data flow model that indicates connections that are bottleneck links (indicated with a line having arrows at both ends) and non-bottleneck links (indicated with a line having an arrow at only one end). To accurately generate the data flow model that includes both of the first domain 302 and the second domain 304, a network entity may require an oracle view (e.g., having access to the capacities and observed data flow rates of links and data flows of both domains). For example, if a network entity of the first domain 302 does not have access to capacities of links within the second domain, the network entity of the first domain may incorrectly determine that a non-bottleneck link is a bottleneck link. This may cause the network entity to incorrectly model the first domain 302, to consume network resources in an attempt to optimize the first domain 302 using incorrect information, and/or to reduce performance of the first domain and the multi-domain network.

As indicated above, FIG. 3 is provided as an example. Other examples may differ from what is described with regard to FIG. 3.

In some aspects described herein, a network entity associated with a domain may improve accuracy of a data flow model generated without an oracle view into neighbor domains (e.g., with only partial information for one or more flows that traverse the domain and terminate outside of the domain). In particular, the network entity may compute the data flow model (e.g., a bottleneck structure of the domain or a bottleneck substructure) using information received from a neighbor domain to update and/or revise the data flow model that was generated without topology (e.g., a configuration of network devices, data flows, and/or links) and flow visibility into the neighbor domain. For example, the network entity may receive an indication of a data flow model of the neighbor domain. The indication of the data flow model of the neighbor domain may include an indication of an expected flow rate of a data flow that traverses the domain and the neighbor domain and/or an indication of a structure (e.g., a configuration of data flows and/or links, and/or capacities and/or flow rates, among other examples). In some aspects, the network entity may receive the indication of the data flow model of the neighbor domain as a simple (e.g., reduced information), anonymous (e.g., not identifying nodes associated with the links or data flows), and/or secure exchange of data flow model information.

The network entity may check an accuracy of the data flow model based at least in part on the indication of the second flow model. For example, if a neighbor node indicates a flow rate for a data flow, with the flow rate differing from an expected flow rate of the data flow that is expected based at least in part on a current iteration of the data flow model, the network entity may determine that the current iteration of the data flow model is inaccurate. The network entity may update the data flow model based at least in part on adding a virtual link to one or more flows that are identified by a neighbor network entity to have a flow rate that differs from the expected flow rate using the current iteration of the data flow model. In this way, the data flow model may use the virtual link to account for a difference in data flow rates as indicated by a current iteration of the data flow model and as indicated by a neighbor network entity (e.g., network node and/or controller). The network entity may then use the updated data flow model to determine whether a bottleneck link is within the domain (indicating that the network entity may be able to cure the bottleneck) or outside of the domain.

Some aspects described herein refer to data flows. In some aspects, a path may represent a set of data flows that include a shared set of links within a domain. For example, a path may include one or more data flows that share a set of links that connect an ingress to a domain to an egress from the domain, a same set of links that connect an ingress to the domain to an end node within the domain, or a same set of links that connect an egress to a source node within the domain. In some aspects, example, a bottleneck structure may be constructed and/or used based at least in part on a set of paths, with each path having information associated with one or more flows that have been collapsed (e.g., combined or reduced) into a single vertex. For example, a path model (e.g., a path gradient graph (PGG)) may include a bottleneck structure with a reduced size (e.g., relative to a bottleneck structure that models data flows individually) based at least in part on collapsing all vertices of data flows that follow a same path into a single vertex (e.g., a path vertex). Using the path model may support a compact representation of a bottleneck structure graph (e.g., with reduced computational complexity and memory storage) without reducing accuracy.

FIGS. 4A and 4B are diagrams illustrating examples 400A, 450A, and 400B associated with multi-domain network data flow modeling, in accordance with the present disclosure. The diagrams of examples 400A and 450A illustrate flows and links within the second domain 304 of the multi-domain network shown in FIG. 3. The diagram of example 400B illustrates flows and links within the first domain 302 of the multi-domain network shown in FIG. 3. The diagrams of examples 400A, 450A, and 400B depict data flow models (e.g., bottleneck substructures or bottleneck structures) that include data flows found within the second domain 304 and the first domain 302 and links found in the second domain 304 and the first domain 302, and edges in a data flow structure of multiple domains of the multi-domain structure that connect the data flows and the links found within the respective domains. If a data flow in a domain is bottlenecked at a link that is not within the domain, a network entity may add a virtual link with a share of data flow rate (e.g., equal to the expected data flow rate of the data flow) and a directed edge from the virtual link to the data flow (e.g., the virtual link is a bottleneck link). The network entities of the first domain and the second domain may each be contained within one computing device or may be distributed over multiple computing devices. The network entities may include a network controller, such as hardware that includes a software-defined network (SDN) controller.

As shown in example 400A, the network entity of the second domain may generate a preliminary data flow model that includes only links that are within the second domain 304 and flows that are within the second domain 304. As shown, the network entity of examples 400A and 450A is unaware of any links outside of the second domain, so the network entity of examples 400A and 450A generates the preliminary data flow model having bottleneck links for all connections of link 322.

However, as shown in FIG. 3, link 322 is not a bottleneck link for flow 310 and flow 316, but links that are outside of the second domain 304 are the bottleneck links for flow 310 and flow 316. In this way, the preliminary data flow model is inaccurate, but the network entity is unaware of the inaccuracy until checking the preliminary data flow model against an indication of a data flow model of the first domain 302.

The network entity may obtain (e.g., receive from another device, among other examples) expected flow rates for the flow 310, the flow 312, and the flow 316 based at least in part on the preliminary data flow model. Based at least in part on the link 322 having, for example, a known capacity of 100 units of data per second (e.g., known because the link is within the second domain 304), the network entity may estimate that flow rates of each flow will be 33.3 units of data per second.

However, the network entity may obtain (e.g., receive from a network device of the first domain 302) a set of expected flow rates that are based at least in part on a flow rate model of the first domain 302. The set of expected flow rates may include a flow rate of 16.6 data units per second for flow 310 and a flow rate of 8.3 data units per second for flow 316. Based at least in part on the indication of the flow rate model of the first domain 302 indicating one or more flow rates that differ from the expected flow rates (e.g., by a threshold amount) that are based at least in part on the flow rate model of the second domain 304, the network entity may determine that the data flow model is inaccurate. In some aspects, the network entity may determine that the flow rate model is inaccurate at flows where the expected flow rate that is based at least in part on the flow rate model of the second domain 304 is greater than the expected flow rate that is based at least in part on the flow rate model of the first domain 302.

As shown in example 450A, the network entity may generate an updated data flow model that is based at least in part on adding a virtual link 405 and a virtual link 410 to the data flow model. The network entity may add virtual links connected to flow 310 and flow 316 based at least in part on the associated expected flow rates as determined from the indication of the data flow model of the first domain 302 being less than the associated expected flow rates as determined from the data flow model of the second domain 304. The network entity may not add a virtual link connected to flow 312 based at least in part on the flow 312 being connected to link 324 that is within the second domain 304.

Based at least in part on the virtual links 405 and 410 being added to the data flow model, the network entity may accurately model the second domain 304. For example, the network entity may accurately model the link 322 as a non-bottleneck link of flow 316 and as a non-bottleneck link of flow 310. Additionally, the network entity may accurately model the links 324 and 322 as both bottleneck links of flow 312 (e.g., based at least in part on having a same amount of available capacity for the flow 312). In this way, the network entity may calculate accurate network derivatives of the second domain 304. These derivatives may be used to optimize the domain for traffic engineering, routing, flow scheduling, capacity planning, resilience analysis, and/or network design, among other examples. In this way, the network device may conserve network resources that may otherwise have been used to attempt to optimize the second domain 304 using incorrect information, and/or may improve performance (e.g., satisfaction of QoS requirements and efficient use of network resources, among other examples) of the second domain and the multi-domain network.

As shown in FIG. 4B, and by example 400B, a network entity of the first domain 302 may generate a data flow model of the first domain 302 with bottleneck links connecting to each flow that terminates outside of the first domain 302. In this example, each of the flows that terminate outside of the first domain 302 is accurately indicated as a bottleneck structure, which may be confirmed based at least in part on receiving an indication of the data flow structure of the second domain 304 and/or another domain. For example, a network entity of the first domain 302 may receive, from the network entity of the second domain 304, an indication that the network entity of the second domain 304 expects data flow rates for the flows 310 and 316 that are higher than expected data flow rates for the flows 310 and 316 that are expected based at least in part on the data flow model of the first domain 302. In this case, the network entity of the first domain 302 may converge on an accurate data flow model with a single iteration.

The following is an example procedure (e.g., an iterative procedure) to generate the data flow models shown in FIG. 4:

```
  1. Set i = 0;
  2. L_0 = L;
  3. FL_0 = FL,
  4. While True:
    4.1. B_i = COMPUTE_BOTTLENECK_STRUCTURE(FL_i, L_i, {c_l for all
in L_i});₃
    4.2. If B_i.r_(f) = r(f, n) for all flow f in F:
      4.2.1. Break;
    4.3. For all flow f in F such that B_i.r(f) > min{r(f,n), for all n in N}
      4.3.1. If FL_i[f] has no virtual link:
        4.3.1.1. Add a new virtual link v to the set of links FL_i[f];
        4.3.1.2. Add virtual link v to the set L_i;
      4.3.2. Set c_v = r(f,n);
    4.4. i = i + l;
    4.5. L_i = L_{i-1};
    4.6. FL_i = FL_{i-l};
  5. Return FL_i, L_i, {c_l, for all l in L_i}.
```

In the example procedures, B_i is an iteration of the data flow model of the multi-domain network, B_i.r(f) is an iteration of a theoretical rate of flow f (e.g., a rate of flow f according to the data flow model B), F is a set of flows ({f_1, . . . , f_{|F|}}) found in a network domain under observation, L is a set of links ({l_1, . . . , l_{|L|}}) found in the network domain under observation, FL is a data store mapping a flow with the subset of links in L that the flow traverses (a flow f can traverse one or more links not in L based at least in part on the network entity having only partial information inherent to multi-domain networking environments), c_l is a capacity of a link l in L, and r*_f is an observed and/or measured steady state of transmission rate of flow f for any flow f in F.

In some aspects, a bottleneck structure may include a path model that is based at least in part on information associated with the data flow model. For example, the path model may include a PGG with a reduced size relative to the data flow model based at least in part on collapsing all vertices of data flows that follow a same path into a single vertex (e.g., a path vertex). Using the path model may support a compact representation of a bottleneck structure graph (e.g., with reduced computational complexity and memory storage) without reducing accuracy or with reducing accuracy by an amount that satisfies an accuracy threshold. For example, the bottleneck structure may include information associated with paths of the domain and/or multi-domain network, which may reduce the size of the bottleneck structure based at least in part on the domain and/or a network having hundreds of paths and millions or billions of flows. In this way, the information of the bottleneck structure may be collapsed into a reduced set of information for data flow management.

In some aspects, the following procedure may be used to generate a path model associated with the data flow model of FIG. 4:

```
1. i = 0; L_0 = L; PL_0 = PL;
2. While True: 2.1. B_i = COMPUTE_BOTTLENECK_STRUCTURE(L_i,
PL_i, C);
  2.2. If B_i.BW(p) == PM(p) for all path p in PL_i:
    2.2.1. Break;
  2.3. For all path p in PL_i such that B_i.BW(p) > PM(p):
    2.3.1. If PL_i[p] has no virtual link:
      2.3.1.1. Add a new virtual link v to the set of links PL_i[p];
      2.3.1.2. Add virtual link v to the set L_i;
    2.3.2. Set C(v) = PM(p);
  2.4. i = i + 1;
  2.5. L_i = L_{i-1};
  2.6. PL_i = PL_{i-1};
3. Return B_i;
```

In some aspects, the network entity may receive the indication of the data flow model of a neighbor domain and/or transmit an indication of the data flow model of the domain using an example procedure:

```
  1. Periodically (e.g., every 5 seconds), perform the following:
    1.1. r(f,n) = LFMD(n)(f), for all neighbors n in N;
    1.2. B(F,L) = COMPUTE_BOTTLENECK_SUBSTRUCTURE_
COOPERATIVE(F, L, {c_l}, {r(f,n)});
  1.3. Send to all my neighbor domains a FLOW_METRIC_ANNOUNCEMENT
message including (1) my domain ID and (2) my flow metric dictionary FMD, where
FMD(f)=B(F,L).r(f);
  2. Upon receiving a FLOW_METRIC_ANNOUNCEMENT from domain DID
carrying the flow metric dictionary FMD:
  2.1. update my local copy of the flow metric table for domain DID as follows:
LFMD(DID)=FMD;
```

where LFMD is a local flow metric dictionary kept by a network entity of each domain, wherein DID is a domain identification, and where LFMD(DID) is an LFMD for a domain based at least in part on a domain identification of the domain.

As indicated above, FIGS. 4A and 4B are provided as an example. Other examples may differ from what is described with regard to FIGS. 4A and 4B.

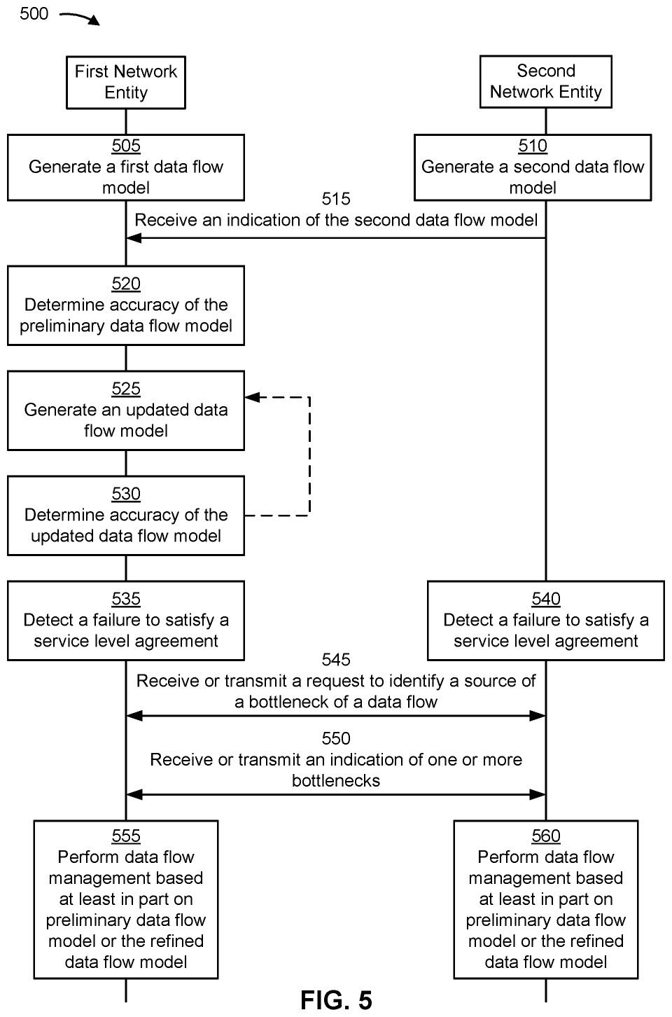

FIG. 5 is a diagram of an example process 500 associated with multi-domain network data flow modeling, in accordance with the present disclosure. As shown in FIG. 5, a first network entity may communicate with a second network entity to cooperatively generate data flow models for a first domain associated with the first network entity and/or for a second domain associated with the second network entity. The first domain may be a neighbor domain of the second domain. The first domain and the second domain may be associated with a multi-domain network in which the first network entity has limited or no visibility of a network configuration of one or more neighbor domains, such as the second domain. In some aspects, one or more data flows of the first domain may traverse the first domain and the second domain. In some aspects, the one or more data flows may be associated with a data stream that has a QoS requirement (e.g., a communication involving UE 120 or another end node). In some aspects, the first network entity may be configured to perform data flow management of the first domain based at least in part on a first data flow model associated with the first domain. For example, the first network entity and/or the second network entity may be responsible for ensuring that bottleneck links of the one or more data flows satisfy the QoS requirement.

As shown by reference number 505, the first network entity may generate a first data flow model. For example, the first network entity may generate the first data flow model using only links and data flows found within the first domain, as described in connection with FIG. 4. In some aspects, the first data flow model indicates one or more of bottleneck links or non-bottleneck links of one or more data flows within the first domain. In some aspects, the data flow model may be based at least in part on information associated with a set of data flow and/or a set of paths (e.g., with information combined from one or more data flows that share a path and/or a set of links). In some aspects, the data flow model may include a PGG model.

As shown by reference number 510, the second network entity may generate a second data flow model. For example, the second network entity may generate the second data flow model using only links and data flows found within the second domain, as described in connection with FIG. 4. In some aspects, the second data flow model indicates one or more of bottleneck links or non-bottleneck links of one or more data flows within the second domain.

As shown by reference number 515, the first network entity may receive an indication of the second data flow model. In some aspects, the first network entity may receive an indication of an expected flow rate of a data flow that traverses the first domain and the second domain. In some aspects, the first network entity may receive an indication of a structure (e.g., data flow, data flow rates, links, link capacities, and/or network nodes, among other examples) of the second data flow model. For example, the indication of the second data flow model may include a set of links of the second data flow model, capacities of the set of links of the second data flow model, one or more bottleneck links of the second data flow model, a set of flows of the second data flow model, and/or one or more flow rates of the set of flows of the second data flow model, among other examples.

In some aspects, the first network entity may transmit a request for the indication of the second data flow model. The first network entity may receive the request for the indication of the second data flow model based at least in part on transmitting the request.

In some aspects, the first network entity may receive a request for an indication of the first data flow model. The first network entity may transmit the indication of the first data flow model to the second network entity based at least in part on receiving the request.

As shown by reference number 520, the first network entity may determine an accuracy of the data flow model. The accuracy of the data flow model may be determined based at least in part on an expected flow rate of a data flow, as indicated in the indication of the second data flow model, differing from a modeled flow rate of the data flow as modeled in the first data flow model. For example, the first data flow model may be determined to be inaccurate based at least in part on the expected flow rate of the data flow differing from a modeled flow rate of the data flow as modeled in the first data flow model. In some aspects, the indication of the second data flow model indicates an error in the first data flow model based at least in part on one or more data flows of the first domain having a bottleneck link outside of the first domain

In some aspects, the first data flow model may be inaccurate based at least in part on one or more data flows of the first domain having a bottleneck link outside of the first domain (e.g., within the second domain). For example, if the one or more data flows of the domain have a bottleneck link outside of the first domain, a first iteration of the first data flow model may inaccurately indicate that a link inside of the first domain is a bottleneck link.

As shown by reference number 525, the first network entity may generate an updated data flow model. In some aspects, the first network entity may selectively update the data flow model based at least in part on an accuracy of the flow model. For example, based at least in part on a determination of inaccuracy, the first network entity may generate the updated data flow model. Based at least in part on a determination of accuracy, an update may be unnecessary and the data flow model may be finalized and ready to use for data flow management.

In some aspects, the first network entity may generate the updated data flow model based at least in part on identifying a data flow for which an expected data flow rate is different, by an amount that satisfies a threshold, between the first data flow model and the second data flow model (e.g., as indicated in the indication of the second data flow model). The first network entity may add a virtual link to a set of links modeled via the data flow model. The virtual link may be associated with the data flow and the measured flow rate. In this way, a bottleneck link may be attributed to the virtual link that represents a link outside of the first domain.

In some aspects, the first network entity may generate a multi-domain data flow model (e.g., as the updated data flow model or as an additional data flow model) that include the first data flow model and the second data flow model. In some aspects, the multi-domain data flow model may include multiple neighbor data flow model (e.g., based at least in part on receiving indications of structures of the neighbor data flow models).

As shown by reference number 530, the first network entity may determine accuracy of the updated data flow model. Based at least in part on the first network entity determining that the updated data flow model is inaccurate, the first network entity may generate another updated data flow model in an iterative process. For example, the first network entity may generate an updated data flow model based at least in part on iteratively updating the data flow model until expected data flow rates using the first data flow model and the second data flow model (e.g., as indicated in the indication of the second data flow model) differ by an amount that satisfies an accuracy threshold.

As shown by reference number 535, the first network entity may detect a failure to satisfy a service level agreement (SLA) for a communication link that traverses one or more data flows of the first domain. In some aspects, the first network entity may be associated with a network (e.g., a wireless network) that includes an end node of the communication link. In this way, the first network entity may be informed regarding the SLA and/or may be responsible for ensuring satisfaction of the SLA.

As shown by reference number 540, the second network entity may detect a failure to satisfy an SLA for a communication link that traverses one or more data flows of the second domain. In some aspects, the second network entity may be associated with a network (e.g., a wireless network) that includes an end node of the communication link. In this way, the second network entity may be informed regarding the SLA and/or may be responsible for ensuring satisfaction of the SLA.

As shown by reference number 545, the first network entity may transmit to, or receive from, the second network entity, a request to identify a source of a bottleneck. For example, the first network entity may detect the failure to satisfy the SLA, may determine that the first domain is not the source of the bottleneck (e.g., a restriction of data flow that causes the communication link to fail to satisfy the SLA), and may transmit the request to one or more neighbor nodes of the multi-domain network. In another example, the second network entity may detect the failure to satisfy the SLA, may determine that the second domain is not the source of the bottleneck, and may transmit the request to one or more neighbor nodes of the multi-domain network.

As shown by reference number 550, the first network entity may transmit to, or receive from, the second network entity, an indication of one or more bottlenecks. For example, the first network entity or the second network entity may transmit the indication in response to receiving the request described in connection with reference number 545. The first network entity may transmit the indication of the one or more bottleneck as indicated in the first data flow model and/or the second network entity may transmit the indication of the one or more bottleneck as indicated in the second data flow model.

In some aspects, the first network entity and/or the second network entity may perform operations described in connection with reference numbers 535-550 using the following procedure:

```
  1. While True:
      1.1. B(F, L) = COMPUTE_BOTTLENECK_SUBSTRUCTURE(F, L, FL,
        {c_l}, {r*_f});
      1.2. For all f in F such that B(F, L).r_f < sla_f:
        1.2.1. If B(F, L).bottlenecks list(f) intersection L is not empty:
          1.2.1.1. Set FD(f) = MY_DID; # Set to my own domain ID
        1.2.2. Else:
          1.2.2.1. Send a WHO_IS_BOTTLENECKING_THIS_FLOW message to
        all domains;
  2.Upon receiving a WHO_IS_BOTTLENECKING_THIS_FLOW message from a
domain DID for a flow f:
      2.1. If B(F, L).bottlenecks_list(f) intersection L is not empty:
        2.1.1. Send an I_AM_BOTTLENECKING_THIS_FLOW message back to
        domain DID.
  3.Upon receiving an I_AM_BOTTLENECKING_THIS_FLOW message from a
    domain DID for a flow f:
      3.1. SetFD(f) = DID.
```

As shown by reference number 555, the first network entity may perform data flow management based at least in part on the data flow model. In some aspects, data flow management may be based at least in part on identifying one or more bottleneck links of the first domain, one or more alternative flows for propagating data, and/or one or more links that are available to link one or more flows, among other examples. In some aspects, data flow management may include traffic engineering, routing, flow control, flow scheduling, capacity planning, network change planning, robustness analysis, service level agreement management, resilience analysis, network modeling, flow performance prediction, and/or resource allocation, among other examples.

As shown by reference number 560, the second network entity may perform data flow management based at least in part on the data flow model. Similar to the data flow management described in connection with reference number 555, data flow management may be based at least in part on identifying one or more bottleneck links of the first domain, one or more alternative flows for propagating data, and/or one or more links that are available to link one or more flows, among other examples. Additionally, or alternatively, in some aspects, data flow management may include traffic engineering, routing, flow control, flow scheduling, capacity planning, network change planning, robustness analysis, service level agreement management, resilience analysis, network modeling, flow performance prediction, and/or resource allocation, among other examples.

Based at least in part on the first network entity updating the data flow model based at least in part on flow rates indicated from a neighbor domain and expected flow rates based at least in part on a current iteration of the data flow model, the data flow model may use the virtual link to account for the flow rate differing from the expected flow rate using a previous iteration of the data flow model. The first network entity may then use the updated data flow model to determine whether a bottleneck link is within the first domain (indicating that the first network entity may be able to cure the bottleneck) or outside of the first domain, among other examples of data flow management.

In this way, the first network entity may conserve network resources that may otherwise have been used to attempt to optimize the first domain using incorrect information, and/or may improve performance (e.g., satisfaction of QoS requirements and efficient use of network resources, among other examples) of the first domain and the multi-domain network.

As indicated above, FIG. 5 is provided as an example. Other examples may differ from what is described with regard to FIG. 5. In some aspects, process 500 may be modified to support path modeling as a type of data flow modeling (e.g., a type of bottleneck structure, such as a PGG). For example, a first modified process may include generating a path model (e.g., based at least in part on combining information associated with data flows based at least in part on having shared paths), obtaining a set of measured flow rates and a set of expected flow rates, and determining an accuracy of the path flow model. The first modified process may include iterations of generating an updated path model and determining an accuracy of the updated path model (e.g., until the updated path model is accurate based at least in part on measured flow rates and expected flow rates). The first modified process may also include performing data flow management based at least in part on the path flow model.

In a second modified process, an additional operation may be performed between operations of the process 500 to combine information from a set of data flows into a set of paths (with the set of paths having fewer members than the set of data flows). For example, the second modified process may include combining data flows into paths to generate a path model in place of generating a data flow model shown by reference number 505. The following operations may be performed on the path model rather than on the data flow model. In some aspects, the second modified process may include reducing information of the updated data flow models to be associated with paths rather than data flows to reduce a data set of the updated data flow models.

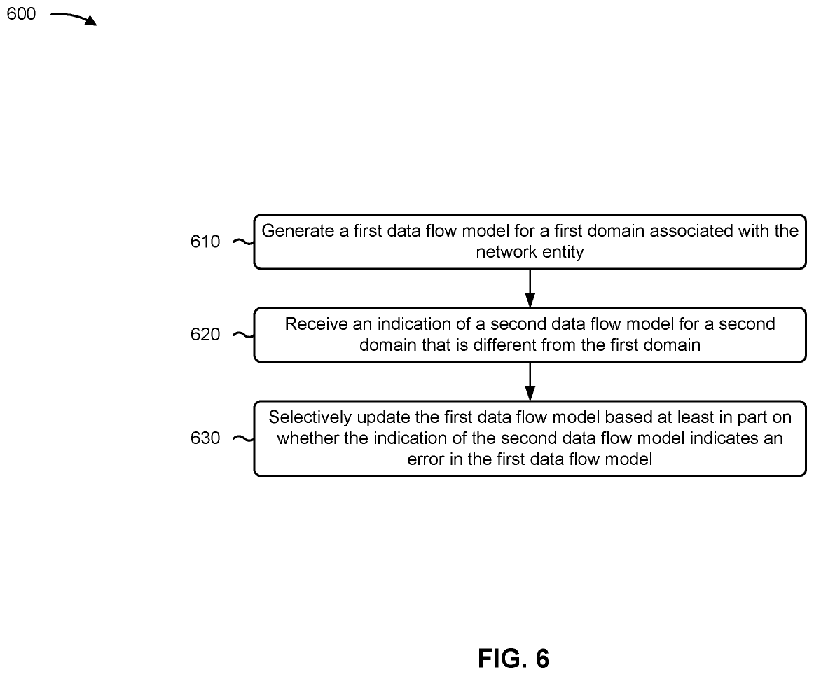

FIG. 6 is a diagram illustrating an example process 600 performed, for example, by a network entity, in accordance with the present disclosure. Example process 600 is an example where the network entity (e.g., device 700, the first network entity, or the second network entity) performs operations associated with multi-domain network data flow modeling. As described herein, a data flow model described in connection with process 600 may include information that is based at least in part on paths (e.g., rather than data flows or in addition to data flows).

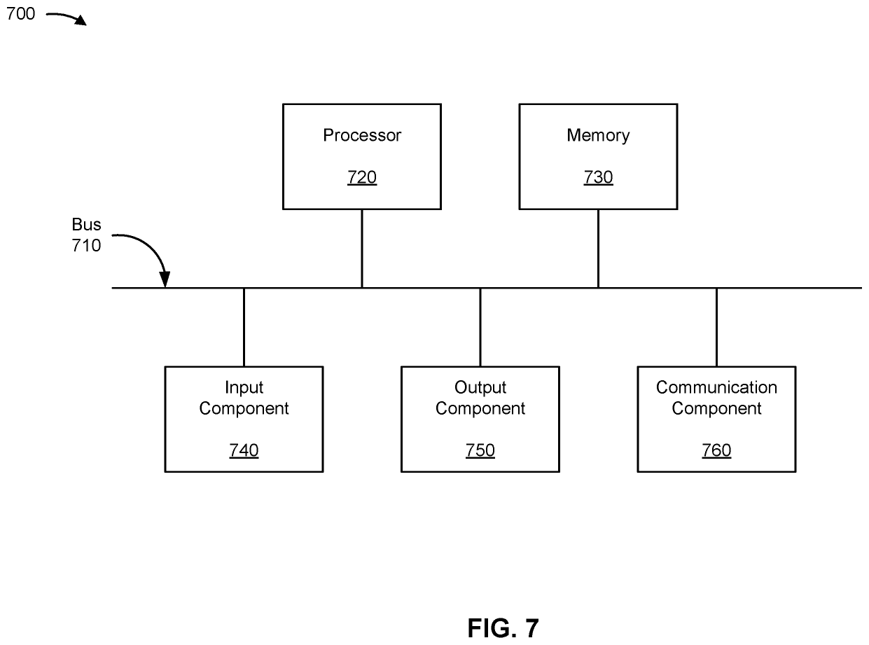

As shown in FIG. 6, in some aspects, process 600 may include generating a first data flow model for a first domain associated with the network entity (block 610). For example, the network entity (e.g., using processor 720 and/or memory 730, depicted in FIG. 7) may generate a first data flow model for a first domain associated with the network entity, as described above.

As further shown in FIG. 6, in some aspects, process 600 may include receiving an indication of a second data flow model for a second domain that is different from the first domain (block 620). For example, the network entity (e.g., using processor 720, memory 730, and/or communication component 760, depicted in FIG. 7) may receive an indication of a second data flow model for a second domain that is different from the first domain, as described above.

As further shown in FIG. 6, in some aspects, process 600 may include selectively updating the first data flow model based at least in part on whether the indication of the second data flow model indicates an error in the first data flow model (block 630). For example, the network entity (e.g., using processor 720 and/or memory 730, depicted in FIG. 7) may selectively update the first data flow model based at least in part on whether the indication of the second data flow model indicates an error in the first data flow model, as described above.

Process 600 may include additional aspects, such as any single aspect or any combination of aspects described below and/or in connection with one or more other processes described elsewhere herein.

In a first aspect, the indication of the second data flow model indicates an expected flow rate of a data flow or a path that traverses between the first domain and the second domain.

In a second aspect, alone or in combination with the first aspect, the indication of the second data flow model indicates the error in the first data flow model based at least in part on the expected flow rate of the data flow or the path differing from a modeled flow rate of the data flow or the path as modeled in the first data flow model.

In a third aspect, alone or in combination with one or more of the first and second aspects, the indication of the second data flow model indicates a structure of the second data flow model, a set of links of the second data flow model, capacities of the set of links of the second data flow model, one or more bottleneck links of the second data flow model, a set of flows of the second data flow model, a set of paths of the second data flow model, and/or one or more flow rates of the set of flows or the set of paths of the second data flow model.

In a fourth aspect, alone or in combination with one or more of the first through third aspects, process 600 includes generating, based at least in part on the second data flow model, a multi-domain data flow model that includes the first data flow model and the second data flow model.

In a fifth aspect, alone or in combination with one or more of the first through fourth aspects, process 600 includes one or more of transmitting a request for the indication of the second data flow model, or receiving a request for an indication of the first data flow model.

In a sixth aspect, alone or in combination with one or more of the first through fifth aspects, the indication of the second data flow model indicates the error in the first data flow model based at least in part on one or more data flows or paths of the first domain having a bottleneck link outside of the first domain.

In a seventh aspect, alone or in combination with one or more of the first through sixth aspects, process 600 includes one or more of performing data flow management based at least in part on the first data flow model; or transmitting an indication of one or more bottlenecks within the first domain based at least in part on the first data flow model.

In an eighth aspect, alone or in combination with one or more of the first through seventh aspects, performing data flow management comprises performing one or more of traffic engineering, routing, flowing control, flowing scheduling, capacity planning, network change planning, robustness analysis, service level agreement management, resilience analysis, network modeling, flowing performance prediction, or resource allocation.

In a ninth aspect, alone or in combination with one or more of the first through eighth aspects, process 600 includes transmitting, to one or more additional network entities associated with one or more additional domains, a request to identify a source of a bottleneck of a data flow or a path.

In a tenth aspect, alone or in combination with one or more of the first through ninth aspects, process 600 includes receiving a request to identify a source of a bottleneck of a data flow, and transmitting an indication that the first domain is the source of the bottleneck of the data flow.

In an eleventh aspect, alone or in combination with one or more of the first through tenth aspects, process 600 includes detecting a failure to satisfy a service level agreement associated with the data flow or the path, wherein transmitting the request to identify the source of the bottleneck of the data flow or the path is based at least in part on detecting the failure to satisfy the service level agreement.

In a twelfth aspect, alone or in combination with one or more of the first through eleventh aspects, the second domain is a neighbor domain relative to the first domain.

In a thirteenth aspect, alone or in combination with one or more of the first through twelfth aspects, process 600 includes receiving a request to identify a source of a bottleneck of a data flow or a path, and transmitting an indication that the first domain is the source of the bottleneck of the data flow or the path.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of example components of a device 700, which may correspond to a network entity described herein, such as the first network entity or the second network entity. In some implementations, the network entity includes one or more devices 700 and/or one or more components of device 700. As shown in FIG. 7, device 700 may include a bus 710, a processor 720, a memory 730, an input component 740, an output component 750, and a communication component 760.

Bus 710 includes one or more components that enable wired and/or wireless communication among the components of device 700. Bus 710 may couple together two or more components of FIG. 7, such as via operative coupling, communicative coupling, electronic coupling, and/or electric coupling. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform one or more operations or processes described elsewhere herein.

Memory 730 includes volatile and/or nonvolatile memory. For example, memory 730 may include random access memory (RAM), read only memory (ROM), a hard disk drive, and/or another type of memory (e.g., a flash memory, a magnetic memory, and/or an optical memory). Memory 730 may include internal memory (e.g., RAM, ROM, or a hard disk drive) and/or removable memory (e.g., removable via a universal serial bus connection). Memory 730 may be a non-transitory computer-readable medium. Memory 730 stores information, instructions, and/or software (e.g., one or more software applications) related to the operation of device 700. In some implementations, memory 730 includes one or more memories that are coupled to one or more processors (e.g., processor 720), such as via bus 710.

Input component 740 enables device 700 to receive input, such as user input and/or sensed input. For example, input component 740 may include a touch screen, a keyboard, a keypad, a mouse, a button, a microphone, a switch, a sensor, a global positioning system sensor, an accelerometer, a gyroscope, and/or an actuator. Output component 750 enables device 700 to provide output, such as via a display, a speaker, and/or a light-emitting diode. Communication component 760 enables device 700 to communicate with other devices via a wired connection and/or a wireless connection. For example, communication component 760 may include a receiver, a transmitter, a transceiver, a modem, a network interface card, and/or an antenna.

Device 700 may perform one or more operations or processes described herein. For example, a non-transitory computer-readable medium (e.g., memory 730) may store a set of instructions (e.g., one or more instructions or code) for execution by processor 720. Processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry is used instead of or in combination with the instructions to perform one or more operations or processes described herein. Additionally, or alternatively, processor 720 may be configured to perform one or more operations or processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

The following provides an overview of some Aspects of the present disclosure:

Aspect 1: A method performed by a network entity, comprising: generating a first data flow model for a first domain associated with the network entity; receiving an indication of a second data flow model for a second domain that is different from the first domain; and selectively updating the first data flow model based at least in part on whether the indication of the second data flow model indicates an error in the first data flow model.

Aspect 2: The method of Aspect 1, wherein the indication of the second data flow model indicates an expected flow rate of a data flow or a path that traverses between the first domain and the second domain.

Aspect 3: The method of Aspect 2, wherein the indication of the second data flow model indicates the error in the first data flow model based at least in part on the expected flow rate of the data flow or the path differing from a modeled flow rate of the data flow or the path as modeled in the first data flow model.

Aspect 4: The method of any of Aspects 1-3, wherein the indication of the second data flow model indicates a structure of the second data flow model, a set of links of the second data flow model, capacities of the set of links of the second data flow model, one or more bottleneck links of the second data flow model, a set of flows of the second data flow model, a set of paths of the second data flow model, and/or one or more flow rates of the set of flows or the set of paths of the second data flow model.

Aspect 5: The method of any of Aspects 1-4, further generating, based at least in part on the second data flow model, a multi-domain data flow model that includes the first data flow model and the second data flow model.

Aspect 6: The method of any of Aspects 1-5, further comprising one or more of: transmitting a request for the indication of the second data flow model; or receiving a request for an indication of the first data flow model.

Aspect 7: The method of any of Aspects 1-6, wherein the indication of the second data flow model indicates the error in the first data flow model based at least in part on one or more data flows or paths of the first domain having a bottleneck link outside of the first domain.

Aspect 8: The method of any of Aspects 1-7 further comprising one or more of: performing data flow management based at least in part on the first data flow model; or transmitting an indication of one or more bottlenecks within the first domain based at least in part on the first data flow model.

Aspect 9: The method of Aspect 8, wherein performing data flow management comprises performing one or more of: traffic engineering, routing, flow control, flow scheduling, capacity planning, network change planning, robustness analysis, service level agreement management, resilience analysis, network modeling, flow performance prediction, or resource allocation.

Aspect 10: The method of any of Aspects 1-9, further comprising: transmitting, to one or more additional network entities associated with one or more additional domains, a request to identify a source of a bottleneck of a data flow or a path.

Aspect 11: The method of Aspect 10, further comprising: detecting a failure to satisfy a service level agreement associated with the data flow or the path, wherein transmitting the request to identify the source of the bottleneck of the data flow or the path is based at least in part on detecting the failure to satisfy the service level agreement.

Aspect 12: The method of any of Aspects 1-11, further comprising: receiving a request to identify a source of a bottleneck of a data flow or a path, and transmitting an indication that the first domain is the source of the bottleneck of the data flow or the path.

Aspect 13, The method of any of Aspects 1-12, further comprising: receiving a request to identify a source of a bottleneck of a data flow or a path, and transmitting an indication that the first domain is the source of the bottleneck of the data flow or the path.

Aspect 14: The method of any of Aspects 1-13, wherein the second domain is a neighbor domain relative to the first domain.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a network entity, comprising:
generating a first data flow model for a first domain associated with the network entity;
receiving an indication of a second data flow model for a second domain that is different from the first domain; and
selectively updating the first data flow model based at least in part on whether the indication of the second data flow model indicates an error in the first data flow model.

2. The method of claim 1, wherein the indication of the second data flow model indicates an expected flow rate of a data flow or a path that traverses between the first domain and the second domain.

3. The method of claim 2, wherein the indication of the second data flow model indicates the error in the first data flow model based at least in part on the expected flow rate of the data flow or the path differing from a modeled flow rate of the data flow or the path as modeled in the first data flow model.

4. The method of claim 1, wherein the indication of the second data flow model indicates one or more of:
a structure of the second data flow model,
a set of links of the second data flow model,
capacities of the set of links of the second data flow model,
one or more bottleneck links of the second data flow model,
a set of flows of the second data flow model,
a set of paths of the second data flow model, or
one or more flow rates of the set of flows or the set of paths of the second data flow model.

5. The method of claim 1, further comprising:
generating, based at least in part on the second data flow model, a multi-domain data flow model that includes the first data flow model and the second data flow model.

6. The method of claim 1, further comprising one or more of:
transmitting a request for the indication of the second data flow model; or
receiving a request for an indication of the first data flow model.

7. The method of claim 1, wherein the indication of the second data flow model indicates the error in the first data flow model based at least in part on one or more data flows or paths of the first domain having a bottleneck link outside of the first domain.

8. The method of claim 1 further comprising one or more of:
performing data flow management based at least in part on the first data flow model; or
transmitting an indication of one or more bottlenecks within the first domain based at least in part on the first data flow model.

9. The method of claim 8, wherein performing data flow management comprises performing one or more of:
traffic engineering,
routing,
flow control,
flow scheduling,
capacity planning,
network change planning,
robustness analysis,
service level agreement management,
resilience analysis,
network modeling,
flow performance prediction, or
resource allocation.

10. The method of claim 1, further comprising:
transmitting, to one or more additional network entities associated with one or more additional domains, a request to identify a source of a bottleneck of a data flow or a path.

11. The method of claim 10, further comprising:
detecting a failure to satisfy a service level agreement associated with the data flow or the path,
wherein transmitting the request to identify the source of the bottleneck of the data flow or the path is based at least in part on detecting the failure to satisfy the service level agreement.

12. The method of claim 1, further comprising:
receiving a request to identify a source of a bottleneck of a data flow or a path, and
transmitting an indication that the first domain is the source of the bottleneck of the data flow or the path.

13. The method of claim 1, wherein the second domain is a neighbor domain relative to the first domain.

14. A network entity comprising:
a memory; and
one or more processors, coupled to the memory, configured to:
generate a first data flow model for a first domain associated with the network entity;
receive an indication of a second data flow model for a second domain that is different from the first domain; and
selectively update the first data flow model based at least in part on whether the indication of the second data flow model indicates an error in the first data flow model.

15. The network entity of claim 14, wherein the indication of the second data flow model indicates an expected flow rate of a data flow or a path that traverses the first domain and the second domain.

16. The network entity of claim 15, wherein the indication of the second data flow model indicates the error in the first data flow model based at least in part on the expected flow rate of the data flow or the path differing from a modeled flow rate of the data flow or path as modeled in the first data flow model.

17. The network entity of claim 14, wherein the indication of the second data flow model indicates one or more of:
a structure of the second data flow model,
a set of links of the second data flow model,
capacities of the set of links of the second data flow model,
one or more bottleneck links of the second data flow model,
a set of flows of the second data flow model,
a set of paths of the second data flow model, or
one or more flow rates of the set of flows or the set of paths of the second data flow model.

18. The network entity of claim 14, wherein the one or more processors are further configured to:
generate, based at least in part on the second data flow model, a multi-domain data flow model that includes the first data flow model and the second data flow model.

19. The network entity of claim 14, wherein the one or more processors are further configured to:
transmit a request for the indication of the second data flow model; or
receive a request for an indication of the first data flow model.

20. The network entity of claim 14, wherein the indication of the second data flow model indicates the error in the first data flow model based at least in part on one or more data flows or paths of the first domain having a bottleneck link outside of the first domain.

21. The network entity of claim 14, wherein the one or more processors are further configured to:
perform data flow management based at least in part on the first data flow model or
transmit an indication of one or more bottlenecks within the first domain based at least in part on the first data flow model.

22. The network entity of claim 21, wherein the one or more processors, to perform data flow management, are configured to perform one or more of:
traffic engineering,
routing,
flow control,
flow scheduling,
capacity planning,
network change planning,
robustness analysis,
service level agreement management,
resilience analysis,
network modeling,
flow performance prediction, or
resource allocation.

23. The network entity of claim 14, wherein the one or more processors are further configured to:
transmit, to one or more additional network entities associated with one or more additional domains, a request to identify a source of a bottleneck of a data flow or a path.

24. The network entity of claim 23, wherein the one or more processors are further configured to:
detect a failure to satisfy a service level agreement associated with the data flow or the path,
wherein transmitting the request to identify the source of the bottleneck of the data flow or the path is based at least in part on detecting the failure to satisfy the service level agreement.

25. The network entity of claim 14, wherein the one or more processors are further configured to:
receive a request to identify a source of a bottleneck of a data flow or a path, and
transmit an indication that the first domain is the source of the bottleneck of the data flow or the path.

26. The network entity of claim 14, wherein the second domain is a neighbor domain relative to the first domain.

27. A non-transitory computer-readable medium storing a set of instructions, the set of instructions comprising:
one or more instructions that, when executed by one or more processors of a network entity, cause the network entity to:
generate a first data flow model for a first domain associated with the network entity;
receive an indication of a second data flow model for a second domain that is different from the first domain; and
selectively update the first data flow model based at least in part on whether the indication of the second data flow model indicates an error in the first data flow model.

28. The non-transitory computer-readable medium of claim 27, wherein the indication of the second data flow model indicates an expected flow rate of a data flow or a path that traverses the first domain and the second domain, or
wherein the indication of the second data flow model indicates a structure of the second data flow model.

29. An apparatus comprising:
means for generating a first data flow model for a first domain associated with the apparatus;
means for receiving an indication of a second data flow model for a second domain that is different from the first domain; and
means for selectively updating the first data flow model based at least in part on whether the indication of the second data flow model indicates an error in the first data flow model.

30. The apparatus of claim 29, wherein the indication of the second data flow model indicates an expected flow rate of a data flow or a path that traverses the first domain and the second domain, or
wherein the indication of the second data flow model indicates a structure of the second data flow model.
